(19) United States
(12) Patent Application Publication
(10) Pub. No.: US 2015/0336110 A1
(43) Pub. Date: Nov. 26, 2015

(54) PRECIPITATION PLATES FOR ELECTROSTATIC PRECIPITATOR

(71) Applicant: Dong Jin OH, Suwon-Si (KR)

(72) Inventor: Dong Jin OH, Suwon-Si (KR)

(21) Appl. No.: 14/338,008

(22) Filed: Jul. 22, 2014

(30) Foreign Application Priority Data
May 22, 2014 (KR) 20-2014-003923

(51) Int. Cl. B03C 3/78

(52) U.S. Cl. CPC B03C 3/78

(57) ABSTRACT

Provided are precipitation plates for an electrostatic precipitator. The precipitation plate for an electrostatic precipitator includes a flow plate having a pattern formed to make a liquid flow in a distributed manner, and a liquid passage which is coupled to an upper side of the flow plate and through which a liquid to be provided to the flow plate flows, wherein the pattern is an arrangement of a plurality of horizontal stripes.

This application claims priority from Korean Utility Model Application No. 20-2014-0003923 filed on May 22, 2014 in the Korean Intellectual Property Office, the disclosure of which is incorporated herein by reference in its entirety.

### BACKGROUND OF THE INVENTIVE CONCEPT

1. Field of the Inventive Concept

The present inventive concept relates to precipitation plates for an electrostatic precipitator, and more particularly, to precipitation plates for an electrostatic precipitator, the precipitation plates using a flowing liquid as a precipitator.

2. Description of the Related Art

An electrostatic precipitator charges fine particles included in a gas such as air by applying an electric field to the gas and collects the charged fine particles using static electricity, thereby purifying the gas. Of electrostatic precipitation techniques, a wet electrostatic precipitation technique additionally uses a cleaning water supply device and a cleaning water circulation device to remove contaminants collected by a precipitation plate. A precipitator using this wet electrostatic precipitation technique includes a precipitation plate.

### SUMMARY OF THE INVENTIVE CONCEPT

Aspects of the present inventive concept provide a precipitation plate structured to make a liquid flow in a distributed manner, thereby increasing the efficiency of removing charged dust particles, etc.

Aspects of the present inventive concept also provide a precipitation plate structured to hold a liquid that is to be provided to the precipitation plate within a liquid passage for a certain period of time, such that the liquid can flow over the whole surface of the precipitation plate.

However, aspects of the present inventive concept are not restricted to the one set forth herein. The above and other aspects of the present inventive concept will become more apparent to one of ordinary skill in the art to which the present inventive concept pertains by referencing the detailed description of the present inventive concept given below.

According to an aspect of the present inventive concept, there is provided a precipitation plate for an electrostatic precipitator. The precipitation plate includes: a flow plate having a pattern formed to make a liquid flow in a distributed manner; and a liquid passage which is coupled to an upper side of the flow plate and through which a liquid to be provided to the flow plate flows, wherein the pattern is an arrangement of a plurality of horizontal stripes.

First grooves and second grooves may be formed in the horizontal stripes and may be arranged alternately.

The horizontal stripes may be arranged parallel to each other.

The horizontal stripes may be arranged at regular intervals.

The pattern may be formed on a front surface and a backside surface of the flow plate.

The flow plate may be coated with a hydrophilic material.

A liquid holder may be formed within the liquid passage, wherein the liquid holder prevents the liquid from flowing out of the liquid passage and holds the liquid within the liquid passage.

The liquid holder may be formed to slope.

According to another aspect of the present inventive concept, there is provided a precipitation plate for an electrostatic precipitator. The precipitation plate includes: a flow plate having a pattern formed on a front surface and a backside surface thereof to make a liquid flow in a distributed manner; a liquid passage which is coupled to an upper side of the flow plate and through which a liquid to be provided to the flow plate flows; and a liquid holder which prevents the liquid from flowing out of the liquid passage and holds the liquid within the liquid passage, wherein the pattern is an arrangement of a plurality of horizontal stripes, and first grooves and second grooves are formed in the horizontal stripes and are arranged alternately.

The horizontal stripes may be arranged parallel to each other.

The horizontal stripes may be arranged at regular intervals.

The liquid holder may be formed to slope.

### BRIEF DESCRIPTION OF THE DRAWINGS

The above and other aspects and features of the present inventive concept will become more apparent by describing in detail exemplary embodiments thereof with reference to the attached drawings, in which:

FIG. 1 is an exploded perspective view of a precipitation plate according to an embodiment of the present inventive concept;

FIG. 2 is a perspective view of a flow plate according to an embodiment of the present inventive concept;

FIG. 3 is a front view of the flow plate shown in FIG. 2;

FIG. 4 is a side view of the flow plate shown in FIG. 2;

FIG. 5 is a perspective view of a liquid passage according to an embodiment of the present inventive concept;

FIG. 6 is a front view of the liquid passage shown in FIG. 5;

FIG. 7 is a plan view of the liquid passage shown in FIG. 5;

FIG. 8 is a cross-sectional view taken along the line A-A′ of FIG. 5;

FIG. 9 is a front view of a flow plate according to another embodiment of the present inventive concept; and

FIG. 10 is a front view of a flow plate according to another embodiment of the present inventive concept.

### DETAILED DESCRIPTION OF THE INVENTIVE CONCEPT

Advantages and features of the present inventive concept and methods of accomplishing the same may be understood more readily by reference to the following detailed description of exemplary embodiments and the accompanying drawings. The present inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the present inventive concept will only be defined by the appended claims. In the drawings, sizes and relative sizes of elements may be exaggerated for clarity. Like reference numerals refer to like elements throughout the specification.

It will be understood that when an element is referred to as being “on” another element, the element can be directly on another element or intervening elements. In contrast, when an element is referred to as being “directly on” another element, there are no intervening elements present.

Spatially relative terms, such as “below,” “beneath,” “lower,” “above,” “upper,” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” or “beneath” can encompass both an orientation of above and below. The device may be otherwise oriented and the spatially relative descriptors used herein interpreted accordingly.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated elements, but do not preclude the presence or addition of one or more other elements.

It will be understood that, although the terms first, second, third, etc., may be used herein to describe various elements, these elements should not be limited by these terms. These terms are only used to distinguish one element from another element. Thus, a first element discussed below could be termed a second element without departing from the teachings of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present inventive concept will now be described more fully with reference to the accompanying drawings, in which exemplary embodiments of the inventive concept are shown.

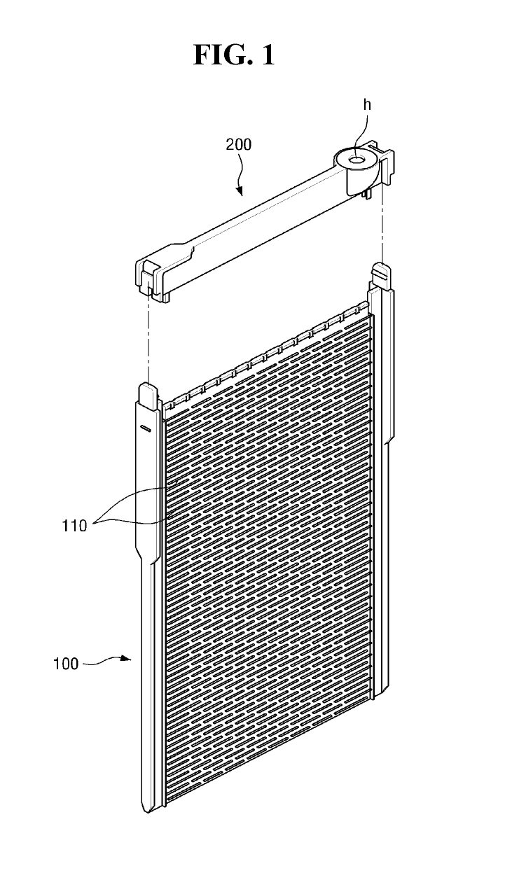

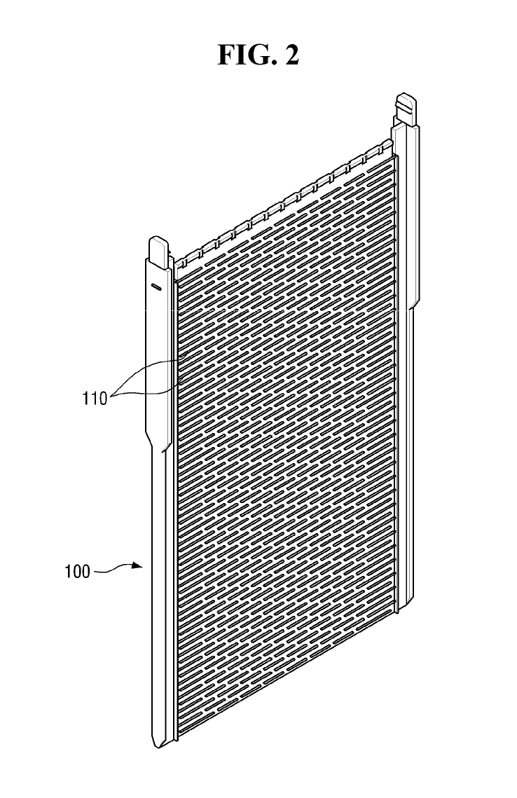

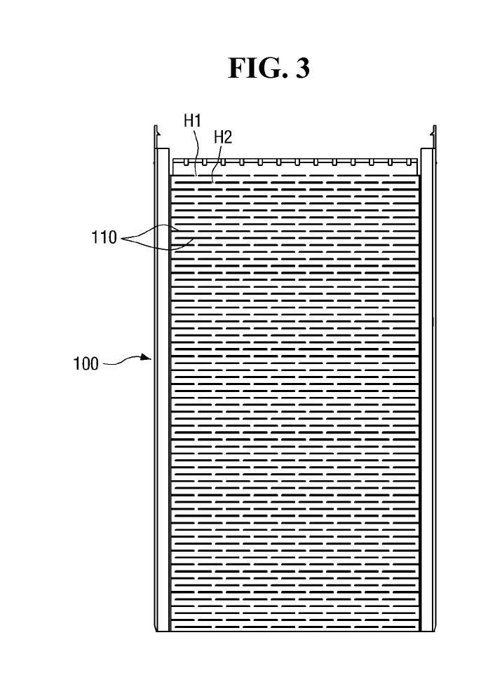

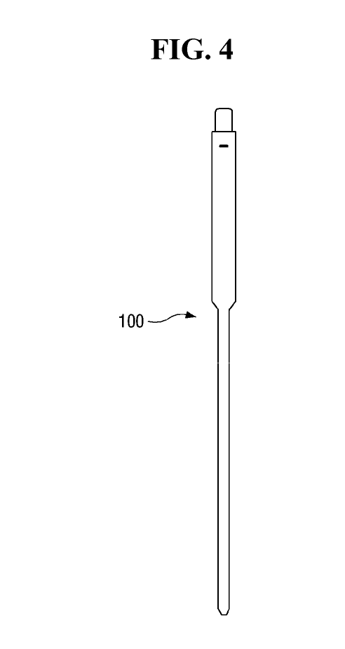

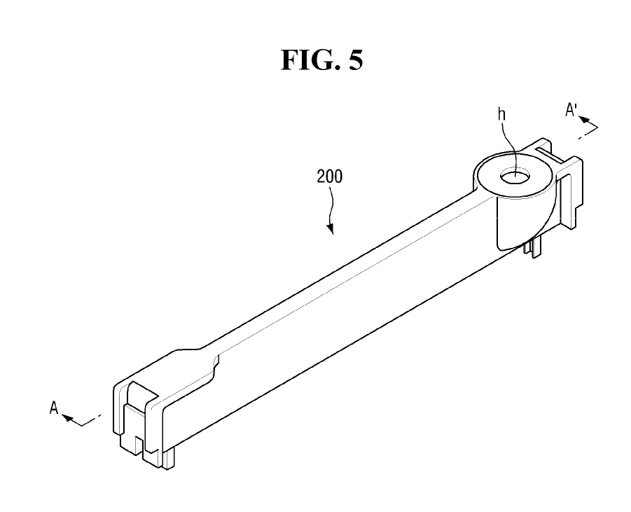

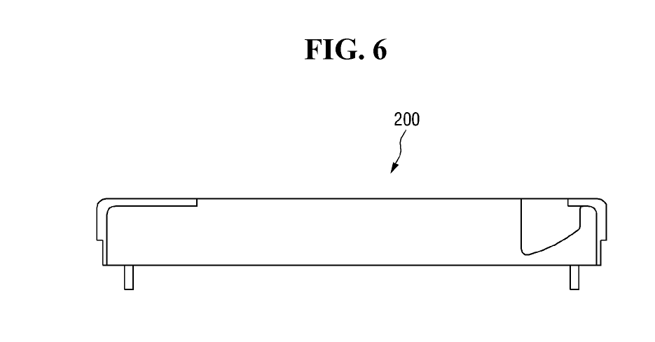

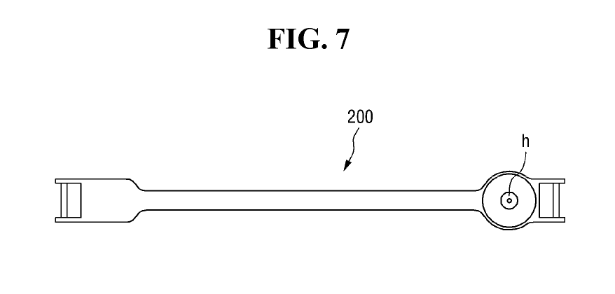

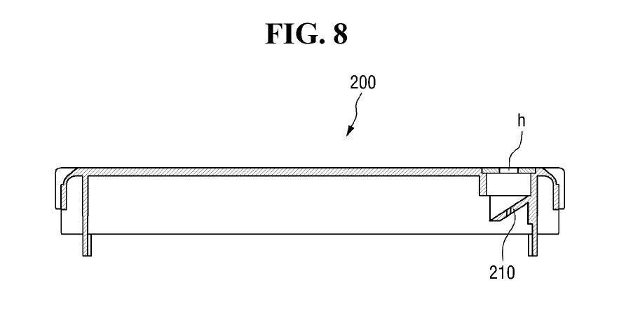

FIG. 1 is an exploded perspective view of a precipitation plate for an electrostatic precipitator according to an embodiment of the present inventive concept. FIG. 2 is a perspective view of a flow plate 100 according to an embodiment of the present inventive concept. FIG. 3 is a front view of the flow plate 100 shown in FIG. 2. FIG. 4 is a side view of the flow plate 100 shown in FIG. 2. FIG. 5 is a perspective view of a liquid passage 200 according to an embodiment of the present inventive concept. FIG. 6 is a front view of the liquid passage 200 shown in FIG. 5. FIG. 7 is a plan view of the liquid passage 200 shown in FIG. 5. FIG. 8 is a cross-sectional view taken along the line A-A′ of FIG. 5.

Referring to FIGS. 1 through 8, the precipitation plate for an electrostatic precipitator according to the current embodiment includes the flow plate 100 and the liquid passage 200.

A pattern 110 is formed in the flow plate 100 to cause a liquid to flow in a distributed manner. The flow plate 100 collects charged dust particles, etc. In the flow plate 100 according to the present inventive concept, a liquid serves as a precipitator. Thus, the liquid flows along the flow plate 100.

The pattern 110 formed in the flow plate 100 enables a liquid to flow along the flow plate 100 in a substantially uniformly distributed manner. Without the pattern 110 in the flow plate 100, a liquid may flow mainly along a side of the flow plate 100 due to its viscosity. To prevent this phenomenon, the pattern 110 is formed in the flow plate 100.

The pattern 110 may be formed on a front surface and a backside surface of the flow plate 100. That is, a liquid may flow along both surfaces (i.e., the front surface and the backside surface) of the flow plate 100.

If a liquid flows along both surfaces of the flow plate 100 as described above, collection efficiency can be increased. The pattern 110 formed on the front surface of the flow plate 100 may have the same shape as the pattern 110 formed on the backside surface of the flow plate 100. However, the present inventive concept is not limited thereto, and the patterns 110 formed on the front surface and the backside surface of the flow plate 100 may have different shapes, if necessary.

The pattern 110 may be, but is not limited to, an arrangement of stripes. In particular, the pattern 110 may be an arrangement of a plurality of horizontal stripes. Here, first grooves H1 and second grooves H2 may be formed in the horizontal stripes of the pattern 110 and may be arranged alternately.

The alternate arrangement of the first and second grooves H1 and H2 may enable a liquid to flow in an evenly distributed manner over the whole surface of the flow plate 100. The surface area of a liquid flowing along the surface of the flow plate 100 affects collection efficiency. That is, the greater the surface area of the liquid, the higher the collection efficiency. In the flow plate 100 according to the present inventive concept, the pattern 110 may be formed as shown in FIG. 1 in order to increase the surface area of a liquid flowing along the flow plate 100.

In addition, the horizontal stripes of the pattern 110 may be formed parallel to each other and arranged at regular intervals. However, the present inventive concept is not limited thereto, and the gap between the horizontal stripes of the pattern 110 or the protruding length of protrusions may be designed in such a way to maximize collection efficiency.

The first grooves H1 may be arranged at equal intervals, and the second grooves H2 may be arranged at equal intervals. However, the present inventive concept is not limited thereto, and the arrangement of the first grooves H1 and the arrangement of the second grooves H2 can be changed to maximize collection efficiency.

The flow plate 100 may be coated with a hydrophilic material. The hydrophilic material may enable a liquid to flow in an evenly distributed manner along the flow plate 100. That is, the flow plate 100 is coated with the hydrophilic material in order to increase the efficiency of collecting charged dust particles, etc.

The liquid passage 200 is coupled to an upper side of the flow plate 100, and a liquid that is to be provided to the flow plate 100 flows through the liquid passage 200. To provide a liquid to the flow plate 100, a liquid supply unit is needed. A liquid supplied from the liquid supply unit may flow into the liquid passage 200 coupled to the upper side of the flow plate 100. Then, the liquid may flow through the liquid passage 200 to the whole surface of the flow plate 100.

A liquid holder 210 may be formed within the liquid passage 200 to prevent a liquid inside the liquid passage 200 from flowing out of the liquid passage 200. That is, a liquid provided into the liquid passage 200 through a hole h is not immediately discharged from the liquid passage 200 to the flow plate 100. Instead, the liquid is held within the liquid passage 200 for a predetermined period of time by the liquid holder 210 and then allowed to flow to the flow plate 100. Accordingly, the liquid can flow over the whole surface of the flow plate 100.

Referring to FIG. 8, the liquid holder 210 may be formed to slope. The liquid holder 210 may hold a liquid injected into the liquid passage 200 within the liquid passage 200 for a predetermined period of time, that is, prevent the liquid from overflowing out of the liquid passage 200.

In addition, a fine hole may be formed in a bottom of the liquid passage 200 to provide a tiny amount of liquid to the flow plate 100 substantially constantly. The fine hole may enable a liquid to be supplied to the whole surface of the flow plate 100.

Flow plates according to other embodiments of the present inventive concept will now be described.

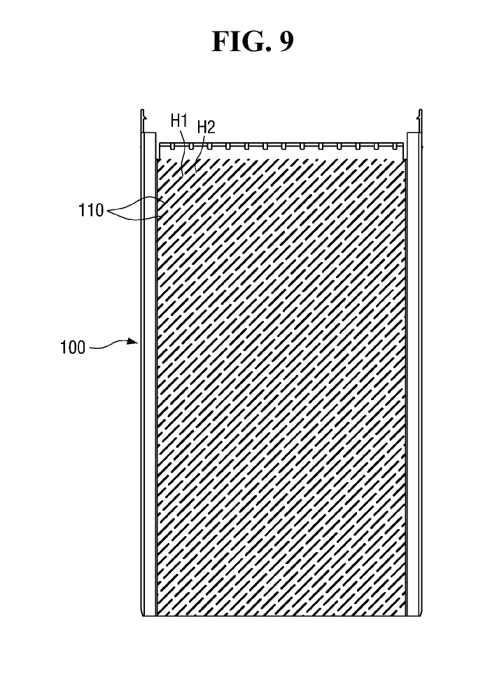

FIG. 9 is a front view of a flow plate 100 according to another embodiment of the present inventive concept. For simplicity, a description of features substantially identical to those of the precipitation plate according to the previous embodiment of FIG. 1 will be omitted.

Referring to FIG. 9, a precipitation plate for an electrostatic precipitator according to another embodiment of the present inventive concept includes the flow plate 100 and a liquid passage 200.

A pattern 110 formed in the flow plate 100 may be an arrangement of sloping stripes as shown in FIG. 9. That is, the pattern 110 may be an arrangement of sloping stripes that enable a liquid to flow in an evenly distributed manner over the whole surface of the flow plate 100.

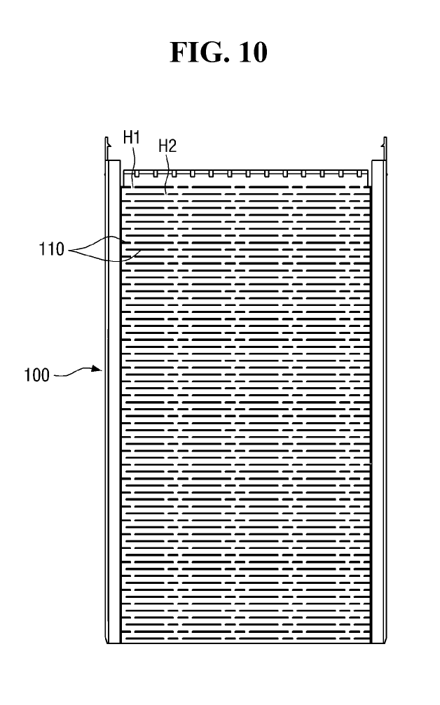

FIG. 10 is a front view of a flow plate 100 according to another embodiment of the present inventive concept. For simplicity, a description of features substantially identical to those of the precipitation plate according to the previous embodiment of FIG. 1 will be omitted.

Referring to FIG. 10, a precipitation plate for an electrostatic precipitator according to another embodiment of the present inventive concept includes the flow plate 100 and a liquid passage 200.

In a pattern 110 formed in the flow plate 100, first grooves H1 and second grooves H2 may be formed at different intervals. That is, the first grooves H1 formed in the pattern 110 may be arranged at different intervals, and the second groove H2 formed in the pattern 110 may be arranged at different intervals. Accordingly, a liquid can flow in an evenly distributed manner over the whole surface of the flow plate 100.

According to the present inventive concept, a certain pattern is formed on a precipitation plate along which a liquid flows. The pattern causes a liquid to flow on the precipitation plate in a distributed manner, thereby maximizing the area of the liquid that charged dust particles, etc. can contact and increasing collection efficiency. In addition, a liquid holder is provided within a liquid passage such that a liquid that is to be provided to the precipitation plate can flow over the whole surface of the precipitation plate. When a liquid for precipitation flows on the whole surface of the precipitation plate, collection efficiency can be increased.

While the present inventive concept has been particularly shown and described with reference to exemplary embodiments thereof, it will be understood by those of ordinary skill in the art that various changes in form and detail may be made therein without departing from the spirit and scope of the present inventive concept as defined by the following claims. The exemplary embodiments should be considered in a descriptive sense only and not for purposes of limitation. The scope of the present inventive concept is defined by the following claims, rather than by the above-described detailed description. The meanings and scope of the claims, and all modifications or modified shapes, which are derived from equivalent concepts thereof, should be understood as being included in the scope of the present inventive concept.

What is claimed is:

1. A precipitation plate for an electrostatic precipitator, the precipitation plate comprising:
a flow plate having a pattern formed to make a liquid flow in a distributed manner; and
a liquid passage which is coupled to an upper side of the flow plate and through which a liquid to be provided to the flow plate flows,
wherein the pattern is an arrangement of a plurality of horizontal stripes.

2. The precipitation plate of claim 1, wherein first grooves and second grooves are formed in the horizontal stripes and are arranged alternately.

3. The precipitation plate of claim 2, wherein the horizontal stripes are arranged parallel to each other.

4. The precipitation plate of claim 3, wherein the horizontal stripes are arranged at regular intervals.

5. The precipitation plate of claim 1, wherein the pattern is formed on a front surface and a backside surface of the flow plate.

6. The precipitation plate of claim 1, wherein the flow plate is coated with a hydrophilic material.

7. The precipitation plate of claim 1, wherein a liquid holder is formed within the liquid passage, wherein the liquid holder prevents the liquid from flowing out of the liquid passage and holds the liquid within the liquid passage.

8. The precipitation plate of claim 7, wherein the liquid holder is formed to slope.

9. A precipitation plate for an electrostatic precipitator, the precipitation plate comprising:
a flow plate having a pattern formed on a front surface and a backside surface thereof to make a liquid flow in a distributed manner;
a liquid passage which is coupled to an upper side of the flow plate and through which a liquid to be provided to the flow plate flows; and
a liquid holder which prevents the liquid from flowing out of the liquid passage and holds the liquid within the liquid passage,
wherein the pattern is an arrangement of a plurality of horizontal stripes, and first grooves and second grooves are formed in the horizontal stripes and are arranged alternately.

10. The precipitation plate of claim 9, wherein the horizontal stripes are arranged parallel to each other.

11. The precipitation plate of claim 10, wherein the horizontal stripes are arranged at regular intervals.

12. The precipitation plate of claim 7, wherein the liquid holder is formed to slope.
